(19) United States
(12) Patent Application Publication
(10) Pub. No.: US 2016/0072293 A1
(43) Pub. Date: Mar. 10, 2016

(54) Multi-Mode Power Converter Power Supply System

(71) Applicant: Astronics Advanced Electronic Systems Corp., Kirkland, WA (US)

(72) Inventor: Jeffrey A. Jouper, Newcastle, WA (US)

(73) Assignee: ASTRONICS ADVANCED ELECTRONIC SYSTEMS CORP., Kirkland, WA (US)

(21) Appl. No.: 14/480,096

(22) Filed: Sep. 8, 2014

(51) Int. Cl. H02J 4/00; B64D 41/00

(52) U.S. Cl. CPC H02J 4/00; B64D 41/00

(57) ABSTRACT

A multi-mode power supply includes both a DC-AC/DC-DC dual-mode converter and a DC-DC converter. In a first mode of operation, the DC-AC/DC-DC dual-mode converter supplies AC power to AC loads and the DC-DC converter supplies power to a mix of steady-state DC loads and transient DC loads. If the transient DC loads request power above that which is available from the DC-DC converter, then a second mode of operation is entered. In the second mode of operation, the DC-AC/DC-DC dual-mode converter ceases to provide AC power to the AC loads and instead is cross coupled with the DC-DC converter, together supplying sufficient DC power to the transient loads that requested power.

### FIELD OF THE DISCLOSURE

The subject matter of the present disclosure generally relates to power supplies, and more particularly relates to power supply systems having multi-mode converters.

### BACKGROUND OF THE DISCLOSURE

Certain challenges are presented by the need to satisfy disparate power requirements of various loads within a power-limited environment, particularly when some of the loads are transient in their power demand. These challenges can be acute where it is also desirable to minimize the size, weight and cost of power supply equipment.

For instance, the power requirements of commercial passenger aircraft cabins can be varied and transient. In an emblematic multi-function aircraft seat, when in active operation a seat motor actuator requires 300 W of direct current (DC) power, an inflight entertainment (IFE) unit requires 75 W of DC power, and a power outlet suitable for use with personal electronic devices (PEDs) requires up to 200 W of alternating current (AC) power. In previous designs, each of these systems required a separate power supply capable of powering each respective system. For the given example, 575 W of power supply capacity would thus be required.

However, realistically significantly less power is required at any given time, as some systems are transient and are in standby, as opposed to operating, condition for extended periods. For instance, in an emblematic passenger aircraft a seat actuator may be in standby more that 90% of the time. The standby power requirements for such a system are typically only in the range of 10-20 W. Therefore, the 300 W power supply for the seat actuator sits idle for the majority of aircraft's use, while the weight of the power supply must be carried continuously. Furthermore, each power supply that attaches to the aircraft power grid must also convert the aircraft power to the native power required for the system it supports. This typically necessitates the inclusion of an electromagnetic interference (EMI) filter stage and a power factor correction (PFC) stage.

Power generated for PED use is generally AC power supplied by an outlet that is also in standby a portion of the time. The loads presented by PEDs are typically of a transient nature as well, as battery powered devices will vary in how much power they draw. This leaves the outlet power supply in a standby condition for approximately 50% of the time. Thus, the power supply supporting the outlet is yet another power supply that is underutilized a significant portion of the time but still must be carried for when its full capacity is required.

The integration of power supplies also presents various challenges when the components the power supplies support have disparate and transient power requirements. Still, reduction of the number of needed power supplies and their associated components is desirable and can reduce unit acquisition and maintenance costs. In vehicle applications, such as in aircraft, weight reduction can result in significant operating cost savings.

The subject matter of the present disclosure is directed to overcoming, or at least reducing the effects of, one or more of the problems set forth above.

### BRIEF SUMMARY OF THE DISCLOSURE

Disclosed is a power supply system for powering transient and steady-state loads.

In an embodiment system, a DC-DC converter and a DC-AC/DC-DC dual-mode converter operate in either a first or second mode of operation. In the first mode of operation, the DC-DC converter supplies DC power to a steady state load and several transient loads that are in a standby state, and the DC-AC/DC-DC converter supplies AC power to an AC load. When one of the transient DC loads request power, the second mode of operation is entered. DC-AC/DC-DC dual-mode converter transitions to producing DC power and is cross coupled with the DC-DC converter. Together the converters satisfy the power requirements of the DC loads. When the transient DC loads are no longer in an active state then the DC-AC/DC-DC dual-mode converter transitions back to supplying AC power to the AC load. When the AC load is a consumer power outlet, the temporary interruption in power to the outlet causes minimal inconvenience as most devices drawing power from outlets contain internal batteries that provide sufficient power for the duration of the interruption.

In environments with multiple loads of varying power requirements, the disclosed system and method allow for effective power management without the need for each component to have an individual power supply capable of supplying its full active-state requirements. Thus, the system's overall weight, size and complexity may be reduced.

### BRIEF DESCRIPTION OF THE DRAWINGS

The foregoing summary, preferred embodiments, and other aspects of the present disclosure will be best understood with reference to a detailed description of specific embodiments, which follows, when read in conjunction with the accompanying drawings, in which:

FIG. 1 is a schematic diagram of an embodiment power supply system.

Like reference numbers and designations in the various drawings indicate like elements.

### DETAILED DESCRIPTION

Disclosed is a multi-mode power supply system for handling dynamic power loading.

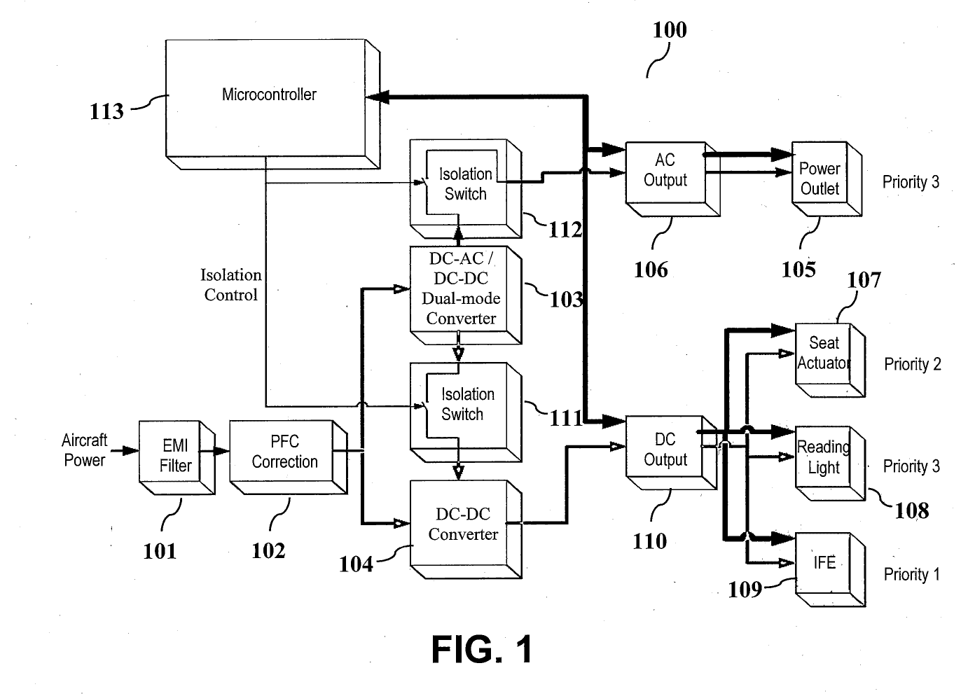

FIG. 1 is a schematic diagram of embodiment power supply system 100, which is installed in an aircraft. Power is received from a power source (not pictured), that is an aircraft generator. EMI filter 101 reduces electromagnetic interference from the power supply and prevents it from contaminating the aircraft's power grid. Power factor correction (PFC) stage 102 regulates the power factor and helps the system meet the power quality requirements of the aircraft. Other embodiments may employ different architectures with respect to these components. Power is passed from PFC stage 102 to DC-AC/DC-DC dual-mode converter 103 and DC-DC converter 104.

Power supply system 100 has a first and second mode of operation. In the first mode of operation, DC-AC/DC-DC dual-mode converter 103 is configured to supply AC power to AC load 105 through AC output 106. DC-DC converter 104 is configured to supply power to transient DC loads 107, 108 and steady-state DC load 109 through DC output 110. First isolation switch 111 is electrically disposed between DC-AC/DC-DC dual-mode converter 103 and DC-DC converter 104. Second isolation switch 112 is electrically disposed between DC-AC/DC-DC dual-mode converter 103 and AC output 106. Microcontroller 113 oversees the functioning of power supply system 100 and communicates with various components using a communication bus. Preferably, microcontroller 113 monitors power usage, power demand, power delivery and generates signals that are sent to DC-AC/DC-DC converter 103.

In the embodiment, AC load 105 is a consumer electrical outlet for supplying power to users in the aircraft's passenger cabin, for instance for use with PEDs such as laptops, cellular telephones, etc. Transient DC load 107 is a seat actuator that allows a passenger to selectively reposition their seat. Transient DC load 108 is a passenger reading light and steady-state DC load 109 is an IFE unit that may include such features as a touch-sensitive video screen. DC-DC converter 104 is of sufficient capacity to simultaneously supply operating power to load 109 and standby power to loads 107 and 108.

In the embodiment, each of the loads is assigned a priority value indicating its importance relative to the other loads. The priority values provide a means by which to prioritize power distribution in power-limited environments, though other schemes may be utilized to determine what loads should be provided power in such circumstances. In the embodiment, three priority levels, 1, 2 and 3, are employed, with a value of 1 being the most important and a value of 3 being the least important. Loads 105 and 108 are each assigned a priority value of 3, load 107 is assigned a priority value of 2, and load 109 is assigned a priority value of 1.

In the embodiment, when in the first mode of operation, transient loads 107 and 108 are in a standby state and thus require small amounts of power, or standby power, while steady-state load 109 will require enough power for active operation, or operating power. In this mode of operation, first isolation switch 111 is in an open position and second isolation switch 112 is in a closed position. DC-AC/DC-DC dual-mode converter 103 supplies power to AC load 105. DC-DC converter 104 provides operating power to steady-state load 109 and provides standby power to transient loads 107 and 108.

When one of the transient DC loads, for instance load 107, requests additional power, microcontroller 113 will determine whether DC-DC converter 104 has sufficient available power to meet the request. In this example, if a passenger wants to move their seat to a new position, they activate a button located on their seat, which requests the movement through a passenger control unit (PCU). The PCU communicates to the seat actuator system which in turn requests the appropriate amount of power from microcontroller 113 to complete the movement requested.

DC-DC converter 104 fulfills the power request if it has sufficient capacity. In this example, the microcontroller would grant the seat actuator permission to move the seat and the action would be completed.

If the DC-DC converter cannot fulfill the power request, then the microcontroller determines whether the requesting DC load has a higher priority value than AC load 105. In this case it does and therefore power supply system 100 enters the second mode of operation. DC-AC/DC-DC dual-mode converter 103 ceases to supply power to AC load 105. Second isolation switch 112 enters an open position and first isolation switch 111 enters a closed position. DC-AC/DC-DC dual mode converter 103 begins producing DC power and is cross coupled with DC-DC converter 104 to provide operating power to load 107. In the example, the cross-coupled converters would then together supply sufficient power for the seat actuator to accomplish the requested move.

When the transient DC load that requested power no longer requires it, the flow of DC power from DC-AC/DC-DC dual-mode converter is halted, first isolation switch 111 enters an open state and second isolation switch 112 enters a closed state. DC-AC/DC-DC dual-mode converter once again produces AC power that is delivered to AC load 105. In the example, this occurs when the passenger releases the seat movement button, after which the seat actuator stops the motion and removes the power request.

In certain embodiments, DC-DC converter 104 is sized so as to be able to supply steady-state power to a steady-state load and standby power to the transient DC loads, while the cross-coupling of DC-AC/DC-DC dual-mode converter 103 and DC-DC converter 104 is necessary to supply operating power to the transient DC loads when certain ones of them request more than their standby power. This configuration can ensure that the system operates at or near its capacity as opposed to having extraneous capacity that is underutilized.

Use of the DC-AC/DC-DC dual-mode converter to produce DC power does result in the interruption of power supply to the AC loads. However, in preferable embodiments the AC loads are consumer power outlets that are used to charge PEDs. PEDs typically have their own battery that can continue to operate even when the outlets are not functioning. Furthermore interruptions in preferred embodiments will be limited in duration because the transient DC loads only require operating power for short durations. Therefore, the overall inconvenience to the user is minimized.

DC-AC/DC-DC dual-mode converters for use in embodiments may selectively supplement DC-DC converters by changing the pulse-width modulation (PWM) value of the current from a sine wave determined by a lookup table to a fixed PWM value equating to the required DC voltage.

In a preferred embodiment, the overall power supply system has available 150 W 28V of DC power and 250 W 110V 60 Hz of AC power when the DC-DC converter is producing DC power and the DC-AC/DC-DC dual-mode converter is producing AC power.

In certain embodiments, whether particular components are in an inactive or standby state can be controlled in part according to the status of the operating environment. For example, in aircraft during critical flight phases such as takeoff and landing, power flow to consumer power outlets may be turned off, as passengers should not be charging devices during this time. Similarly, seat actuators for reclining passenger seats may be disabled as passengers should keep their seats in the upright position.

Regarding the structure of the communication bus connecting the microcontroller and various components, it should be understood that any communication bus structure that allows for sufficient reaction to loading conditions may be employed. Without limitation, such bus structures may employ CANbus, Ethernet, RS-485 or serial communication. Various information may be exchanged over the communication bus, for instance components can indicate their power or voltage requirements.

Embodiments of the present disclosure may provide various advantages over previous systems.

For instance, significant weight savings may be achieved in an embodiment system supplying power to a multi-function aircraft passenger seat. In previous designs, separate power converters for supporting an IFE unit, a consumer power outlet, a reading light and a seat actuator would together weight approximate 8 pounds and require 575 W of power supply capacity. Each of the power supplies would also require an EMI filter and a PFC stage. However, if the power supply system for the seat were limited to 400 W of total capacity, only a single interface to the aircraft power grid would be required. Also the need for EMI filters and PFC stages would be reduced, along with the need for more complex cabling. An embodiment 400 W power supply system having a multimode converter would weigh approximately 4 pounds, resulting in a weight reduction of approximately 50% or 4 pounds over the previous design. These savings are for a single passenger seat. Additional weight savings for connectors and cables may also be achieved. Moreover, these weight savings are multiplied as the number of seats taking advantage of the disclosed subject matter increases. Substantial savings in equipment, maintenance and operating costs may therefore be achieved. Power supply weight savings may be especially pronounced in aircraft having first and business class seating.

System reliability and reduced heat loading may also be benefits of certain embodiments. Additional advantages will be apparent to those of ordinary skill in the art to which the present disclosure pertains.

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention. For instance, although the described embodiments relate to aircraft and particular load types, it should be understood that various embodiments in other environmental settings and with other numbers and types of loads are within the scope of the present disclosure.

What is claimed:

1. A power supply system, comprising:
a DC-AC/DC-DC dual-mode converter;
a DC-DC converter;
at least one steady state DC load, at least one transient DC load, and at least one AC load;
wherein when in a first mode of operation the DC-AC/DC-DC dual-mode converter is configured to provide AC power to the AC loads and the DC-DC converter is configured to provide DC operating power to the steady state DC loads and DC standby power to the transient DC loads;
wherein when in a second mode of operation the DC-AC/DC-DC dual-mode converter is cross coupled with the DC-DC converter and together supply DC operating power to at least one of the transient DC loads and the steady state DC loads.

2. The system of claim 1, further comprising a microcontroller configured to cause the DC-AC/DC-DC dual-mode converter and DC-DC converter to operate in the second mode of operation when at least one of the transient DC loads, having a higher priority value than a priority value of each of the AC loads, is requesting power and there is insufficient additional power available from the DC-DC converter.

3. The system of claim 2 wherein transition between the first mode of operation and the second mode of operation and the cross coupling of the DC-AC/DC-DC converter with the DC-DC converter are facilitated by a first and second isolation switch.

4. The system of claim 2, wherein the DC-AC/DC-DC dual-mode converter and the DC-DC converter are configured to receive power from a power source through an electromagnetic interference (EMI) filter and a power factor correction (PFC) stage.

5. The system of claim 4 wherein the power source is a generator on an aircraft.

6. The system of claim 5 wherein the transient DC loads include a seat actuator and a reading light, the steady state DC loads include an inflight entertainment system, and the AC loads include a consumer power outlet.

7. The system of claim 2, wherein the DC-DC converter is capable of simultaneously supplying operating power to the steady-state DC loads and standby power to the transient DC loads while the power supply system is in the first mode of operation.

8. A method of power management, comprising the steps of:
providing a DC-AC/DC-DC dual-mode converter capable of selectively outputting DC or AC power;
providing a DC-DC converter;
wherein the DC-AC/DC-DC dual-mode converter and the DC/DC converter each receive input power from a power source;
supplying, in a first mode of operation, DC operating power from the DC-DC converter to at least one steady-state DC load and DC standby power to at least one transient DC load and supplying AC power from the DC-AC/DC-DC dual-mode converter to at least one AC load;
wherein the AC loads, steady-state DC loads and transient DC loads are each assigned a priority value;
receiving a request for operating power from one of the transient DC loads;
if adequate additional power is not available from the DC-DC converter and the transient DC loads requesting power each have a priority value higher than priority values of the AC loads, then loads with a lowest priority value are the AC loads, entering a second mode of operation in which the supply of power to the AC loads is halted, the AC-DC/DC-DC converter transitions to a DC mode and is cross coupled with the DC-DC converter to supply operating power to the transient DC loads requesting power.

9. The method of claim 8, further comprising the steps of:
returning the DC-AC/DC-DC dual-mode converter and the DC-DC converter to the first mode of operation when the transient DC loads are no longer requesting operating power.

10. The method of claim 9, wherein a microcontroller controls whether the DC-AC/DC-DC dual-mode converter and the DC-DC converter are operating in either the first mode of operation or the second mode of operation.

11. The method of claim 8 wherein transition between the first mode of operation and the second mode of operation and the cross coupling of the DC-AC/DC-DC converter to the DC-DC converter are facilitated by a first and second isolation switch.

12. The method of claim 10, wherein the DC-AC/DC-DC dual-mode converter and the DC-DC converter receive power from the power source through an electromagnetic interference (EMI) filter and a power factor correction (PFC) stage.

13. The method of claim 12 wherein the power source is a generator on an aircraft.

14. The method of claim 13 wherein the transient DC loads include a seat actuator and a reading light, the steady state DC loads include an inflight entertainment system, and the AC loads include a consumer power outlet.

15. The method of claim 14, wherein the DC-DC converter is capable of simultaneously supplying DC operating power to the steady-state DC loads and DC standby power to the transient DC loads without cross coupling of the DC-AC/DC-DC dual-mode converter and the DC-DC converter.

16. A power supply system, comprising:
a power factor correction (PFC) stage configured to receive power from a power source;
a DC-AC/DC-DC dual-mode converter configured to supply power to an AC load through an AC output;
a DC-DC converter configured to supply power to a plurality of DC loads through a DC output, the DC loads including at least one transient load and at least one steady state load;
a first isolation switch electrically disposed between the DC-AC/DC-DC dual-mode converter and the DC-DC converter;
a second isolation switch electrically disposed between the DC-AC/DC-DC dual-mode converter and the AC output;
a microcontroller configured to control the first and second isolation switches and selectively cause the DC-AC/DC-DC dual-mode converter to enter one of an AC mode in which the first isolation switch is open and the second isolation switch is closed and DC-AC/DC-DC dual-mode converter supplies AC power to the AC load, and a DC mode in which the first isolation switch is closed and the second isolation switch is open and the DC-AC/DC-DC dual-mode converter is cross-coupled with the DC-DC converter and supplies DC power to one or more of the transient DC loads that is requesting operating power.

17. The power supply system of claim 16 wherein the power source is a generator on an aircraft.

18. The power supply system of claim 17 wherein the DC loads include a seat actuator, an inflight entertainment system, and a reading light and the AC loads include a consumer power outlet.

19. The power supply system of claim 16, wherein the microcontroller controls whether the DC-AC/DC-DC dual-mode converter operates in an AC mode or a DC mode according to a priority scheme in which each of the loads are assigned a priority value.
